(19) United States
(12) Patent Application Publication
(10) Pub. No.: US 2026/0238150 A1
(43) Pub. Date: Aug. 13, 2026

(54) CONTROL DEVICE

(71) Applicant: KABUSHIKI KAISHA TOYOTA JIDOSHOKKI, Kariya-shi, Aichi (JP)

(72) Inventors: Kazuki ASAHINA, Kariya-shi (JP); Akira IDE, Kariya-shi (JP); Kiyoshi UETSUJI, Kariya-shi (JP); Shinji DOKI, Nagoya-shi (JP); Rongjiao HAO, Nagoya-shi (JP)

(73) Assignee: KABUSHIKI KAISHA TOYOTA JIDOSHOKKI, Kariya-shi, Aichi (JP)

(21) Appl. No.: 19/158,995

(22) PCT Filed: Feb. 27, 2024
(86) PCT No.: PCT/JP2024/006912

§ 371 Date: Aug. 22, 2025

(30) Foreign Application Priority Data
Feb. 28, 2023 (JP) 2023-030411

(51) Int. Cl. H02P 21/18; H02P 21/04; H02P 21/22; H02P 21/34; H02P 27/06

(52) U.S. Cl. CPC H02P 21/18; H02P 21/04; H02P 21/22; H02P 21/34; H02P 27/06

(57) ABSTRACT

When position estimation is not possible at the time of starting a motor (M) or at the time of sensorless control, an upper arm short circuit drive signal for simultaneously turning on three-phase upper arm switching elements (SW1, SW3, SW5) of an inverter (2) and simultaneously turning off three-phase lower arm switching elements (SW2, SW4, SW6) or a lower arm short circuit drive signal for simultaneously turning off the upper arm switching elements (SW1, SW3, SW5) and simultaneously turning on the lower arm switching elements (SW2, SW4, SW6) is generated.

### TECHNICAL FIELD

The present invention relates to a control device of a motor.

### BACKGROUND ART

There is a motor control device that estimates a position (electrical angle) of a rotor of a motor using an extended electromotive force estimated based on a voltage command value, and controls an operation of each of switching elements of an inverter by a voltage command value generated based on the position. Patent Literature 1 discloses a related technique.

By the way, if on and off timings of the switching elements vary due to individual differences or differences in temperature characteristics between the switching elements, an error occurs between the voltage command value and a true value. Further, the magnitude of the error is constant regardless of the magnitude of an angular velocity of the rotor. As a result, since the extended electromotive force decreases when the angular velocity of the rotor is relatively low (in a low-speed range), the error is relatively large, so that a signal-to-noise ratio of the extended electromotive force deteriorates, and the estimation accuracy of the position of the rotor deteriorates.

Therefore, when the angular velocity of the rotor of the motor is relatively low at the time of starting the motor, the estimation accuracy of the position of the rotor deteriorates, so that there is a possibility that the motor is in a step-out state and the motor cannot be restarted.

### CITATION LIST

### Patent Literature

Patent Literature 1: JP 2022-85227 A

### SUMMARY OF INVENTION

### Technical Problem

An object according to one aspect of the present invention is to suppress a step-out state when a motor is started.

### Solution to Problem

A control device according to one aspect of the present invention is a control device that generates a drive signal for controlling an inverter driving a motor, and includes: a current value conversion unit that converts current flowing through the motor into a γ-axis current value and a δ-axis current value; a γ-δ current command value output unit that outputs a γ-axis current command value and a δ-axis current command value; a γ-δ voltage command value calculation unit that calculates a γ-axis voltage command value based on the γ-axis current value and the γ-axis current command value and calculates a d-axis voltage command value based on the δ-axis current value and the δ-axis current command value; a drive signal conversion unit that converts the γ-axis voltage command value and the δ-axis voltage command value into the drive signal; an estimation unit that calculates an estimated position that is an estimated value of a position of the motor; and a first determination unit that determines whether or not position estimation of the motor is possible by the estimation unit, in which an upper arm short circuit drive signal or a lower arm short circuit drive signal is generated when the motor is started or when the first determination unit determines that the position estimation of the motor is not possible, the upper arm short circuit drive signal being the drive signal for simultaneously turning on three-phase upper arm switching elements of the inverter and simultaneously turning off three-phase lower arm switching elements of the inverter, the lower arm short circuit drive signal being the drive signal for simultaneously turning off the three-phase upper arm switching elements of the inverter and simultaneously turning on the three-phase lower arm switching elements of the inverter, and the estimation unit calculates the estimated position that is the estimated value of the position of the motor based on the current flowing through the motor when the upper arm short circuit drive signal or the lower arm short circuit drive signal is generated.

The control device may include a second determination unit, and the second determination unit may be configured to determine whether or not the position estimation of the motor is possible based on the current flowing through the motor by the upper arm short circuit drive signal or the lower arm short circuit drive signal.

As described above, since the upper arm short circuit drive signal or the lower arm short circuit drive signal is generated when the motor is started or when it is determined that the position estimation is not possible, it is possible to prevent occurrence of an error between a voltage command value and a true value by varying on/off states of the switching elements. As a result, even when the angular velocity of the motor is relatively low, it is possible to suppress deterioration in estimation accuracy of a position of a rotor, and a step-out state is suppressed.

Further, the control device may be configured to generate the drive signal for supplying three-phase alternating current to the motor when the second determination unit determines that the position estimation of the motor is possible.

Further, the control device may be configured to start a timer and generate the drive signal for causing the current flowing through the motor to have a constant value when the second determination unit determines that a value of the current flowing through the motor is smaller than a threshold current and the position estimation of the motor is possible, and to generate the upper arm short circuit drive signal or the lower arm short circuit drive signal after a lapse of a first predetermined time.

Further, the estimation unit may be configured to calculate an estimated extended electromotive force, which is an estimated value of an extended electromotive force generated in the motor, based on the γ-axis current value, the δ-axis current value, the γ-axis voltage command value, and the δ-axis voltage command value, and to calculate the estimated position that is the estimated value of the position of the motor based on the estimated extended electromotive force, and the first determination unit may be configured to determine that the position estimation is not possible when the estimated extended electromotive force is smaller than a threshold, and to generate the upper arm short circuit drive signal or the lower arm short circuit drive signal.

### Advantageous Effects of Invention

According to the present invention, it is possible to suppress the step-out state when the motor is started.

### BRIEF DESCRIPTION OF DRAWINGS

FIG. 1 is a diagram illustrating an example of a control system according to an embodiment.

FIG. 2 is a flowchart illustrating an operation of a computation unit at the time of restarting a motor.

FIG. 3 is a view illustrating an example of an actual angular velocity and an angular velocity command value at the time of restarting the motor.

### DESCRIPTION OF EMBODIMENTS

An embodiment will be described below in detail with reference to the drawings.

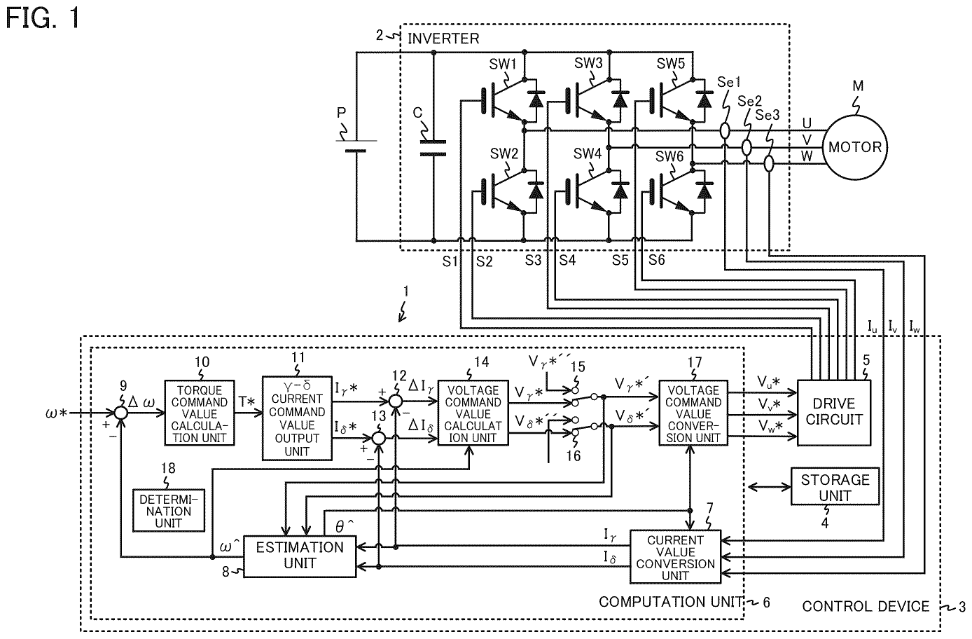

FIG. 1 is a diagram illustrating an example of a control system according to the embodiment.

A control system 1 illustrated in FIG. 1 includes, for example, a motor M mounted on a vehicle such as an electric forklift or a plug-in hybrid vehicle, an inverter 2 that drives the motor M, and a control device 3 that outputs a drive signal to the inverter 2.

The motor M is, for example, a surface magnet synchronous motor or an embedded magnet synchronous motor.

The inverter 2 drives the motor M by power supplied from a power source P, and includes a capacitor C, switching elements SW1 to SW6 (for example, insulated gate bipolar transistors (IGBTs)), and current sensors Se1 to Se3. That is, one terminal of the capacitor C is connected to a positive terminal of the power source P and collector terminals of the switching elements SW1, SW3, and SW5 (upper arm switching elements), and the other terminal of the capacitor C is connected to a negative terminal of the power source P and emitter terminals of the switching elements SW2, SW4, and SW6 (lower arm switching elements). A connection point between an emitter terminal of the switching element SW1 and a collector terminal of the switching element SW2 is connected to a U-phase input terminal of the motor M via the current sensor Se1. A connection point between an emitter terminal of the switching element SW3 and a collector terminal of the switching element SW4 is connected to a V-phase input terminal of the motor M via the current sensor Se2. A connection point between an emitter terminal of the switching element SW5 and a collector terminal of the switching element SW6 is connected to a W-phase input terminal of the motor M via the current sensor Se3.

The capacitor C smooths a voltage output from the power source P and input to the inverter 2.

The switching element SW1 is turned on or off based on a drive signal s1 output from the control device 3. The switching element SW2 is turned on or off based on a drive signal s2 output from control device 3. The switching element SW3 is turned on or off based on a drive signal s3 output from control device 3. The switching element SW4 is turned on or off based on a drive signal s4 output from control device 3. The switching element SW5 is turned on or off based on a drive signal s5 output from control device 3. The switching element SW6 is turned on or off based on a drive signal s6 output from control device 3. When each of the switching elements SW1 to SW6 is turned on or off, a DC voltage output from the power source P is converted into three AC voltages having phases different from each other by 120 degrees, the AC voltages are applied to the U-phase, V-phase, and W-phase input terminals of the motor M, whereby a rotor of the motor M rotates.

The current sensor Se1 includes a Hall element, a shunt resistor, or the like, detects a U-phase current value Iu flowing through a U-phase of the motor M, and outputs the U-phase current value Iu to the control device 3. Further, the current sensor Se2 includes a Hall element, a shunt resistor, or the like, detects a V-phase current value Iv flowing through a V-phase of the motor M, and outputs the V-phase current value Iv to the control device 3. Further, the current sensor Se3 includes a Hall element, a shunt resistor, or the like, and detects a W-phase current value Iw flowing through a W-phase of the motor M and outputs the W-phase current value Iw to the control device 3. Note that the three current sensors Se1 to Se3 are provided in the present embodiment, but any two of the three may be provided instead of the three.

The control device 3 includes a storage unit 4, a drive circuit 5, and a computation unit 6. The control device 3 drives the motor M by controlling the inverter 2.

The storage unit 4 includes a random access memory (RAM), a read only memory (ROM), or the like.

The drive circuit 5 includes an integrated circuit (IC) or the like, compares a voltage value of a carrier wave (triangular wave, sawtooth wave, or reverse sawtooth wave, or the like) with a U-phase voltage command value Vu*, a V-phase voltage command value Vv*, and a W-phase voltage command value Vw* output from the computation unit 6, and outputs the drive signals s1 to s6 according to the comparison result to gate terminals of the switching elements SW1 to SW6, respectively.

For example, the drive circuit 5 outputs the drive signal s1 at a high level and outputs the drive signal s2 at a low level when the U-phase voltage command value Vu* is equal to or larger than the voltage value of the carrier wave, and outputs the drive signal s1 at a low level and outputs the drive signal s2 at a high level when the U-phase voltage command value Vu* is smaller than the voltage value of the carrier wave. Further, the drive circuit 5 outputs the drive signal s3 at a high level and outputs the drive signal s4 at a low level when the V-phase voltage command value Vv* is equal to or larger than the voltage value of the carrier wave, and outputs the drive signal s3 at a low level and outputs the drive signal s4 at a high level when the V-phase voltage command value Vv* is smaller than the voltage value of the carrier wave. Further, the drive circuit 5 outputs the drive signal s5 at a high level and outputs the drive signal s6 at a low level when the W-phase voltage command value Vw* is equal to or larger than the voltage value of the carrier wave, and outputs the drive signal s5 at a low level and outputs the drive signal s6 at a high level when the W-phase voltage command value Vw* is smaller than the voltage value of the carrier wave.

The computation unit 6 includes a microcomputer or the like, and includes a current value conversion unit 7, an estimation unit 8, a subtraction unit 9, a torque command value calculation unit 10, a γ-δ current command value output unit 11, a subtraction unit 12, a subtraction unit 13, a voltage command value calculation unit 14, switches 15 and 16, a voltage command value conversion unit 17, and a determination unit 18. For example, the current value conversion unit 7, the estimation unit 8, the subtraction unit 9, the torque command value calculation unit 10, the γ-δ current command value output unit 11, the subtraction unit 12, the subtraction unit 13, the voltage command value calculation unit 14, the switch 15, the switch 16, the voltage command value conversion unit 17, and the determination unit 18 are configured as the microcomputer executes a program stored in the storage unit 4.

The current value conversion unit 7 converts the U-phase current value Iu, the V-phase current value Iv, and the W-phase current value Iw into a γ-axis current value Iγ and a δ-axis current value Iδ using an estimated position θ\hat{ } of the rotor output from the estimation unit 8. That is, the current value conversion unit 7 converts current flowing through the motor M into the γ-axis current value Iγ and the δ-axis current value Iδ The current value conversion unit 7 may have a function of inputting two-phase current values among the U-phase current value Iu, the V-phase current value Iv, and the W-phase current value Iw, and calculating a current value of the remaining one phase from the input two-phase current values.

Note that a γ-δ coordinate system is an estimated rotating coordinate system, and is a coordinate system in which an axis corresponding to a δ-axis of a d-q coordinate system is a γ-axis and an axis corresponding to a q-axis is a δ-axis. The d-q coordinate system is a rotating coordinate system in which an N-pole direction of a magnet of the motor M is the δ-axis and a direction orthogonal to the δ-axis is the q-axis. Further, the estimated position θ\hat{ } is an estimated value of a position θ of the rotor of the motor M.

For example, the current value conversion unit 7 converts the U-phase current value Iu, the V-phase current value Iv, and the W-phase current value Iw into the γ-axis current value Iγ and the δ-axis current value Iδ using a transformation matrix C1 expressed by the following Formula 1.

### [Mathematical Expression 1]

$$C 1 = \sqrt{\frac{2}{3}} [ \begin{matrix}cos θ \hat{} & cos ( θ \hat{} - 2 π / 3 ) & cos ( θ \hat{} + 2 π / 3 ) \\ - sin θ \hat{} & - sin ( θ \hat{} - 2 π / 3 ) & - sin ( θ \hat{} + 2 π / 3 )\end{matrix} ] \qquad Formula 1$$

The subtraction unit 9 calculates an angular velocity difference Δω between an estimated angular velocity ω\hat{ } output by the estimation unit 8 and an angular velocity command value ω* input from the outside.

The torque command value calculation unit 10 calculates a torque command value T* using the angular velocity difference Δω output from the subtraction unit 9. For example, the torque command value calculation unit 10 refers to information (not illustrated) stored in the storage unit 4 in which angular velocities of the motor M are associated with torques of the motor M, and obtains a torque associated with an angular velocity corresponding to the angular velocity difference Δω as the torque command value T*.

The γ-δ current command value output unit 11 outputs a γ-axis current command value Iγ* and a δ-axis current command value Iδ* using the torque command value T*. For example, the γ-δ current command value output unit 11 refers to information (not illustrated) stored in the storage unit 4 in which the torques of the motor M are associated with the γ-axis current command values Iγ* and the δ-axis current command values Iδ*, and obtains the γ-axis current command value Iγ* and the δ-axis current command value Iδ* associated with the torque corresponding to the torque command value T*. Note that the γ-δ current command value output unit 11 may be configured to output the γ-axis current command value Iγ* and the δ-axis current command value Iδ* using the torque command value T* input from the outside. In such a configuration, the subtraction unit 9 and the torque command value calculation unit 10 are omitted.

The subtraction unit 12 calculates a difference γ-axis current command value ΔIγ between the γ-axis current command value Iγ* output from the γ-δ current command value output unit 11 and the γ-axis current value Iγ output from the current value conversion unit 7.

The subtraction unit 13 calculates a difference δ-axis current command value ΔIδ between the δ-axis current command value Iδ* output from the γ-δ current command value output unit 11 and the δ-axis current value Iδ output from the current value conversion unit 7.

The voltage command value calculation unit 14 converts the difference γ-axis current command value ΔIγ output from the subtraction unit 12 and the difference δ-axis current command value ΔIδ output from the subtraction unit 13 into a γ-axis voltage command value Vγ* and a 8-axis voltage command value Vδ*. For example, the voltage command value calculation unit 14 calculates the γ-axis voltage command value Vγ* by calculation of the following Formula 2 and calculates the δ-axis voltage command value Vδ* by calculation of the following Formula 3. Note that Kp denotes a constant of a proportional term of PI control, Ki denotes a constant of an integral term of the PI control, ω\hat{ } denotes an estimated angular velocity calculated by the estimation unit 8 in a previous control period, Ld denotes a d-axis inductance component of the motor M, Lq denotes a q-axis inductance component of the motor M, and KE denotes an induced voltage constant.

$$V γ * = Kp Δ I γ + \int ( Ki Δ I γ ) - ω \hat{} LqI γ \qquad Formula 2$$

$$V δ * = Kp Δ I δ + \int ( Ki Δ I δ ) + ω \hat{} LqI δ + ω \hat{} KE \qquad Formula 3$$

That is, the subtraction units 12 and 13 and the voltage command value calculation unit 14 function as a γ-δ voltage command value calculation unit that calculates the γ-axis voltage command value Vγ* based on the γ-axis current value Iγ and the γ-axis current command value Iγ* and calculates the δ-axis voltage command value Vδ* based on the δ-axis current value Iδ and the δ-axis current command value Iδ*.

The switch 15 is configured to be capable of selecting whether to output a γ-axis voltage command value Vγ*″ (an upper arm short circuit drive signal or a lower arm short circuit drive signal to be described later) for performing three-phase short circuit control to be described later to the voltage command value conversion unit 17 as a γ-axis voltage command value Vγ*′ or to output the γ-axis voltage command value Vγ* calculated by the voltage command value calculation unit 14 to the voltage command value conversion unit 17 as the γ-axis voltage command value Vγ*′. Further, the switch 16 is configured to be capable of selecting whether to output a d-axis voltage command value Vδ*″ (the upper arm short circuit drive signal or the lower arm short circuit drive signal to be described later) for performing the three-phase short circuit control to be described later to the voltage command value conversion unit 17 as a δ-axis voltage command value Vδ*′ or to output the δ-axis voltage command value Vδ* calculated by the voltage command value calculation unit 14 to the voltage command value conversion unit 17 as the δ-axis voltage command value Vδ*′.

The voltage command value conversion unit 17 converts the γ-axis voltage command value Vγ*′ and the δ-axis voltage command value Vδ*′ into the U-phase voltage command value Vu*, the V-phase voltage command value Vv*, and the W-phase voltage command value Vw* by using the estimated position θ\hat{ } output from the estimation unit 8. For example, the voltage command value conversion unit 17 converts the γ-axis voltage command value Vγ*′ and the δ-axis voltage command value Vδ*′ into the U-phase voltage command value Vu*, the V-phase voltage command value Vv*, and the W-phase voltage command value Vw* using a transformation matrix C2 expressed by the following Formula 4.

$$\begin{matrix}[ Mathematical Expression 2 ] & \\ C 2 = \sqrt{\frac{2}{3}} [ \begin{matrix}cos θ \hat{} & - sin θ \hat{} \\ cos ( θ \hat{} - 2 π / 3 ) & - sin ( θ \hat{} - 2 π / 3 ) \\ cos ( θ \hat{} + 2 π / 3 ) & - sin ( θ \hat{} + 2 π / 3 )\end{matrix} ] & Formula 4\end{matrix}$$

The voltage command value conversion unit 17 outputs the U-phase voltage command value Vu*, the V-phase voltage command value Vv*, and the W-phase voltage command value Vw* to the drive circuit 5. That is, it can be said that the voltage command value conversion unit 17 and the drive circuit 5 function as a drive signal conversion unit that converts the γ-axis voltage command value Vγ* and the δ-axis voltage command value Vδ* into a drive signal and outputs the drive signal to the inverter 2.

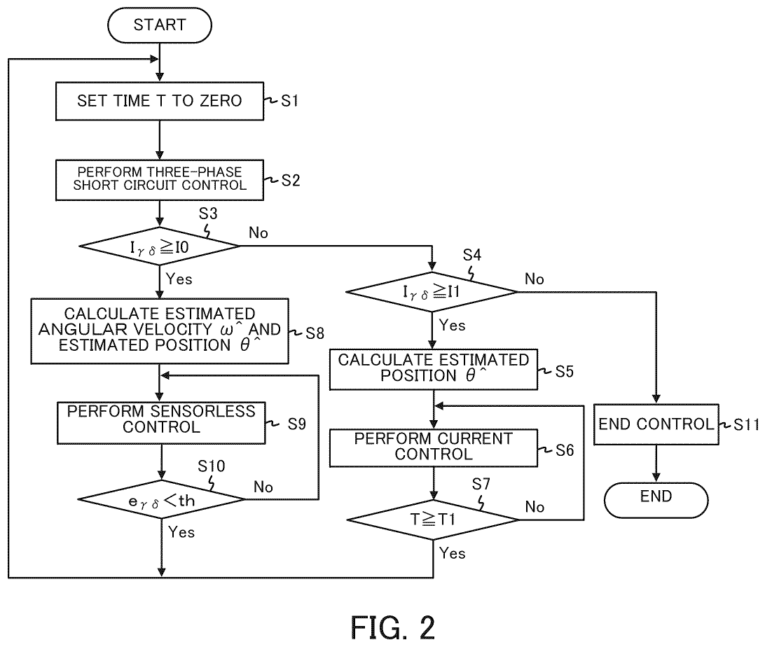

The determination unit 18 as a first determination unit determines whether or not position estimation of the motor M is possible by the estimation unit 8. The determination is performed in step S10 during normal sensorless control as in step S9 of a flowchart of FIG. 2 illustrating an operation of the computation unit 6 at the time of restarting the motor M to be described later.

The estimation unit 8 has a function of calculating the estimated angular velocity ω\hat{ } and the estimated position θ\hat{ }. As a method of calculating the estimated angular velocity ω\hat{ } and the estimated position θ\hat{ }, for example, a method using an extended electromotive force can be considered.

### Example of <Method Using Extended Electromotive Force>

The estimation unit 8 calculates an estimated extended electromotive force e\hat{ }, which is an estimated value of an extended electromotive force (EEMF) e generated in the motor M based on the γ-axis current value Iγ, the δ-axis current value Iδ the γ-axis voltage command value Vγ*′, the δ-axis voltage command value Vδ*′, the estimated angular velocity ω\hat{ } stored in the storage unit 4, and motor parameters which can be estimated in advance. That is, it can be said that the estimation unit 8 calculates the estimated extended electromotive force e\hat{ }, which is the estimated value of the extended electromotive force e generated in the motor M, based on the γ-axis current value Iγ, the δ-axis current value Iδ, the γ-axis voltage command value Vγ*′, and the δ-axis voltage command value Vδ*′. Specifically, the estimation unit 8 calculates the estimated extended electromotive force θ\hat{ } using an observer (motor model) expressed by the following Formula 5. The estimated extended electromotive force e\hat{ } includes a γ-axis estimated extended electromotive force eγ\hat{ } and a δ-axis estimated extended electromotive force eδ\hat{ } as vector components.

$$\begin{matrix}[ Mathematical Expression 3 ] & \\ [ \begin{matrix}{e}_{γ}^{\hat{}} \\ {e}_{δ}^{\hat{}}\end{matrix} ] = [ \begin{matrix}{V}_{γ} {*}^{′} \\ {V}_{δ} {*}^{′}\end{matrix} ] - [ \begin{matrix}{R}^{\hat{}} + {pL}_{d}^{′} & {ω}^{\hat{}} {L}_{q}^{\hat{}} \\ {ω}^{\hat{}} {L}_{q}^{\hat{}} & {R}^{\hat{}} + {pL}_{d}^{\hat{}}\end{matrix} ] [ \begin{matrix}{I}_{γ} \\ {I}_{δ}\end{matrix} ] & Formula 5\end{matrix}$$

Note that p denotes a time derivative operator d/dt. A winding resistance R\hat{ }, a d-axis inductance Ld\hat{ }, and a q-axis inductance Lq\hat{ } are estimated values of motor parameters of the motor M to be controlled, and are estimated in advance by measurement or the like using the motor M. The reason why the estimated values are used instead of actual values of the motor parameters of the motor M is that the motor parameters vary depending on the temperature and the current flowing through the motor M.

Next, the estimation unit 8 calculates a position error Δθ\hat{ } based on the estimated extended electromotive force θ\hat{ }. Specifically, the position error Δθ\hat{ } is calculated from the estimated extended electromotive force e\hat{ } by the following Formula 6.

$$\begin{matrix}[ Mathematical Expression 4 ] & \\ Δ {θ}^{\hat{}} = {tan}^{- 1} ( \frac{- {e}_{γ}^{\hat{}}}{{e}_{δ}^{\hat{}}} ) & Formula 6\end{matrix}$$

Next, the estimation unit 8 obtains the estimated angular velocity ω\hat{ } based on the position error Δθ\hat{ }. Specifically, the estimation unit 8 calculates the estimated angular velocity ω\hat{ } by, for example, multiplying the position error Δθ\hat{ } by a predetermined transfer function. Then, the estimation unit 8 calculates the estimated position θ\hat{ } based on the estimated angular velocity ω\hat{ } and the position error Δθ\hat{ }. Specifically, for example, the estimation unit 8 calculates the estimated position θ\hat{ } by adding a temporary estimated position, obtained by integrating the estimated angular velocity ω\hat{ }, and a corrected position error obtained by multiplying the position error Δθ\hat{ } by the predetermined transfer function. Note that the position error Δθ\hat{ } is multiplied by the predetermined transfer function, but is not necessarily multiplied by the predetermined transfer function. Thereafter, the estimation unit 8 stores the calculated estimated angular velocity ω\hat{ } and the estimated position θ\hat{ } in the storage unit 4, outputs the estimated angular velocity ω\hat{ } to the subtraction unit 9 and the voltage command value calculation unit 14, and outputs the estimated position θ\hat{ } to the current value conversion unit 7 and the voltage command value conversion unit 17.

Here, when a request for stopping the motor M is received from a host device, the control device 3 stops the output of the U-phase voltage command value Vu*, the V-phase voltage command value Vv*, and the W-phase voltage command value Vw* without forcibly stopping the motor M. Therefore, the motor M is in a free-run state of rotating by inertia. Thereafter, when a request for restarting the motor M is received from the host device, the control device 3 restarts the motor M.

FIG. 2 is the flowchart illustrating the operation of the computation unit 6 at the time of restarting the motor M. Note that a case where the determination unit 18 determines that the position estimation is not possible based on the extended electromotive force (Formula 8 to be described later) in a normal operation other than the time of restart is the same as a case where it is determined as Yes in step S10 to be described later, and thus will be described together.

First, the computation unit 6 sets a time T of a timer to zero and then starts the timer (step S1).

Next, the computation unit 6 performs the three-phase short circuit control for performing control such that the switching elements SW1, SW3, and SW5 of three-phase upper arms included in the inverter 2 are simultaneously turned off and the switching elements SW2, SW4, and SW6 of three-phase lower arms are simultaneously turned on (step S2).

Specifically, the switch 15 is switched to output the γ-axis voltage command value Vγ*″ for performing the three-phase short circuit control to the voltage command value conversion unit 17, and the switch 16 is switched to output the δ-axis voltage command value Vδ*″ for performing the three-phase short circuit control to the voltage command value conversion unit 17.

As a result, the U-phase voltage command value Vu*, the V-phase voltage command value Vv*, and the W-phase voltage command value Vw* for performing the three-phase short circuit control are output from the voltage command value conversion unit 17, and the lower arm short circuit drive signal, which is a drive signal for performing the three-phase short circuit control, is output from the drive circuit 5 to the inverter 2.

Note that the lower arm short circuit drive signal in step S2 is output for a short period (for example, several μs). Further, instead of the lower arm short circuit drive signal, the upper arm short circuit drive signal, which is a drive signal for simultaneously turning on the switching elements SW1, SW3, and SW5 and simultaneously turning off the switching elements SW2, SW4, and SW6, may be output from the drive circuit 5 to the inverter 2.

Next, the computation unit 6 calculates a γ-δ-axis current value Iγδ from the following Formula 7 using the γ-axis current value Iγ and the δ-axis current value Iδ calculated from a value of the current flowing through the motor M by the lower arm short circuit drive signal, and the determination unit 18 as a second determination unit determines whether the calculated γ-δ-axis current value Iγδ is equal to or larger than a first threshold current I0 (step S3). The first threshold current I0 is, for example, a minimum value of the γ-δ-axis current value Iγδ when the estimated position θ\hat{ } with required estimation accuracy can be calculated, and is assumed to be obtained in advance by an experiment, a simulation, or the like. Note that the current value flowing through the motor M increases as the rotation speed of the rotor increases, and thus, the accuracy of the estimated position θ\hat{ } to be calculated increases, and the probability that step-out occurs can be reduced. Therefore, the required estimation accuracy refers to, for example, estimation accuracy with which step-out is less likely to occur even when sensorless control is performed.

$$\begin{matrix}[ Mathematical Expression 5 ] & \\ {I}_{γδ} = \sqrt{{I}_{γ}^{2} + {I}_{δ}^{2}} & Formula 7\end{matrix}$$

In step S3, when the γ-δ-axis current value Iγδ is smaller than the first threshold current I0 (step S3: No), the processing proceeds to step S4.

In step S4, it is determined whether the γ-δ-axis current value Iγδ is equal to or larger than a second threshold current I1. The second threshold current I1 is, for example, a value smaller than the first threshold current I0, and is a minimum value of the γ-δ-axis current value Iγδ with which the estimated position θ\hat{ } can be calculated, and is assumed to be obtained in advance by an experiment, a simulation, and the like.

In step S4, when the γ-δ-axis current value Iγδ is equal to or larger than the second threshold current I1 (step S4: Yes), the timer is started after the time T of the timer is set to zero, and the estimated position θ\hat{ } is calculated from the estimated extended electromotive force e\hat{ } calculated by setting the term including Vγ*′, Vδ*′, and ω\hat{ } in Formula 5 to zero from the γ-axis current value IV and the δ-axis current value Iδ calculated from a value of the current flowing through the motor M by the lower arm short circuit drive signal (step S5). That is, when the γ-δ-axis current value Iγδ is equal to or larger than the second threshold current I1, the determination unit 18 as the second determination unit determines that the position estimation is possible, and causes a transition from the three-phase short circuit control to current control.

Then, the control device 3 performs the current control using the estimated position θ\hat{ } calculated in step S5 (step S6). In the current control, the control device 3 performs on/off control of the switching elements SW1 to SW6 such that the current flowing through the motor M has a constant value for a predetermined time set in advance, thereby increasing the angular velocity of the rotor. For example, the switching elements SW1 to SW6 are repeatedly turned on and off by setting the δ-axis current command value Iδ* to be described later to a constant value (for example, a maximum value). In the present embodiment, the switching elements SW1 to SW6 are controlled to be turned on/off such that the current flowing through the motor M has the constant value.

Note that, at the time of the current control, the control device 3 only needs to perform control such that the current flowing through the motor M has the constant value for the predetermined time set in advance, and then may perform control so as to vary the current flowing through the motor M.

Next, the computation unit 6 determines whether the time T is equal to or longer than the first predetermined time T1 (step S7).

In step S7, the current control is continuously performed when the time T is shorter than the first predetermined time T1 (step S7: No), and the processing returns to step S1 when the time T is equal to or longer than the first predetermined time T1 (step S7: Yes). The first predetermined time T1 is a time taken to increase the γ-δ-axis current value Iγδ by a predetermined current value by increasing the rotational speed of the rotor, and is assumed to be obtained in advance by an experiment, a simulation, or the like.

Further, when the γ-δ-axis current value Iyo is equal to or larger than the first threshold current I0 (step S3: Yes), the computation unit 6 calculates the estimated angular velocity ω\hat{ } and the estimated position θ\hat{ } from the estimated extended electromotive force e\hat{ } that is calculated using all the parameters of Formula 5 from the γ-axis current value Iγ and the δ-axis current value Iδ calculated from a value of the current flowing through the motor M by the lower arm short circuit drive signal (step S8). That is, when the γ-δ-axis current value Iγδ is equal to or larger than the first threshold current I0, the determination unit 18 as the second determination unit determines that the position estimation is possible, and causes a transition from the three-phase short circuit control to the sensorless control.

Then, the control device 3 performs the sensorless control using the estimated angular velocity ω\hat{ } and the estimated position θ\hat{ } calculated in step S8 (step S9). At the time of the sensorless control, the control device 3 generates a drive signal for supplying three-phase alternating current to the motor M. In other words, the control device 3 performs on/off control of the switching elements SW1 to SW6 so as to rotate the motor M at a desired rotational speed.

Further, the computation unit 6 determines whether a γ-δ-axis extended electromotive force eγδ calculated by the following Formula 8 from the estimated extended electromotive force e\hat{ }, which is the estimated value of the extended electromotive force e generated by the drive signal for supplying the three-phase alternating current to the motor M, is equal to or larger than a threshold th (step S10).

$$\begin{matrix}[ Mathematical Expression 6 ] & \\ {e}_{γδ} = \sqrt{{( {e}_{γ}^{\hat{}} )}^{2} + {( {e}_{δ}^{\hat{}} )}^{2}} & Formula 8\end{matrix}$$

Then, the sensorless control is continuously performed when it is determined in step S10 that the γ-δ-axis extended electromotive force eγδ is equal to or larger than the threshold th (step S10: No), and the processing returns to step S1 when the γ-δ-axis extended electromotive force eγδ is smaller than the threshold th (step S10: Yes). For example, it is assumed that the threshold th is a minimum value of the γ-δ-axis extended electromotive force eγδ in a case where sensorless control can be performed, and is obtained in advance by an experiment, a simulation, or the like. That is, the determination unit 18 as the first determination unit determines that speed estimation and the position estimation can be performed by the estimation unit 8 and causes the sensorless control to continue when the γ-δ-axis extended electromotive force eγδ is equal to or larger than the threshold th, and determines that the position estimation is not possible by the estimation unit 8 and causes a transition from the sensorless control to the three-phase short circuit control when the γ-δ-axis extended electromotive force eγδ is smaller than the threshold th.

Further, when the γ-δ-axis current value Iγδ is smaller than the second threshold current I1 (step S4: No), the computation unit 6 ends the drive control of the motor M (step S11). That is, when the γ-δ-axis current value Iγδ is smaller than the second threshold current I1, the determination unit 18 as the second determination unit determines that a state in which at least the position estimation is possible has not been achieved even though the three-phase short circuit control is performed, and ends the drive control of the motor M.

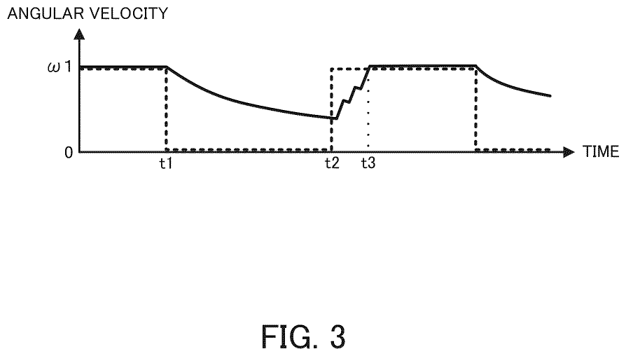

Here, FIG. 3 is a view illustrating an example of an actual angular velocity and the angular velocity command value ω* at the time of restarting the motor M. Note that a horizontal axis of two-dimensional coordinates illustrated in FIG. 3 indicates time, and a vertical axis indicates the angular velocity. Further, a solid line illustrated in FIG. 3 indicates the actual angular velocity, and a broken line indicates the angular velocity command value ω*.

First, at time t1, the angular velocity command value ω* becomes zero from w1, the drive control of the motor M is stopped, and then the actual angular velocity gradually decreases.

Next, when the angular velocity command value ω* is switched from zero to ω1 at time t2 when the motor M is restarted, the three-phase short circuit control is performed. In a case where the γ-δ-axis current value Iγδ calculated based on the γ-axis current value Iγ and the δ-axis current value Iδ calculated from a value of current flowing through the motor M by the three-phase short circuit control is smaller than the first threshold current I0 and the γ-δ-axis current value Iγδ is equal to or larger than the second threshold current I1, the current control and the three-phase short circuit control are alternately repeated until the γ-δ-axis current value Iγδ is equal to or larger than the first threshold current I0, so that the angular velocity of the rotor increases. In the example illustrated in FIG. 3, it is assumed that the current control is performed three times until the γ-δ-axis current value Iγδ is equal to or larger than the first threshold current I0. Note that the current control may be performed only once in accordance with the γ-δ-axis current value Iγδ at the time of restarting the motor M.

Then, when the γ-δ-axis current value Iγδ becomes equal to or larger than the first threshold current I0 at time t3, a transition is made from the three-phase short circuit control to the sensorless control.

As described above, the control device 3 according to the embodiment is configured to perform the three-phase short circuit control when the determination unit 18 as the first determination unit determines that the position estimation is not possible due to a relatively low extended electromotive force at the time of starting the motor M or at the time of the sensorless control, or after the current control is performed for a certain period of time, so that the estimation accuracy of the estimated position θ\hat{ } can be improved. In general, in the normal sensorless control (PWM control), when the motor M is started or when the extended electromotive force is relatively low (when the angular velocity of the rotor is relatively low), an error (dead time error) between a true value and each of the U-phase voltage command value Vu*, the V-phase voltage command value Vv*, and the W-phase voltage command value Vw* is relatively larger as the extended electromotive force is lower. Thus, a signal-to-noise ratio of the extended electromotive force deteriorates, and the estimation accuracy of the position of the rotor deteriorates. Therefore, as compared with the normal sensorless control (PWM control), the influence of the dead time error can be removed by performing the three-phase short circuit control when the motor M is started or when the extended electromotive force is relatively low and the determination unit 18 determines that the position estimation is not possible as in the present embodiment, so that it is possible to improve the signal-to-noise ratio of the extended electromotive force and to improve the estimation accuracy of the estimated position θ\hat{ }. As a result, even when the angular velocity of the motor M is relatively low, it is possible to suppress the deterioration in the estimation accuracy of the position of the rotor and to suppress a step-out state.

Further, in the control device 3 of the embodiment, the actual angular velocity can be increased by performing the current control when the γ-δ-axis current value Iγδ is smaller than the first threshold current I0 and the γ-δ-axis current value Iγδ is equal to or larger than the second threshold current I1, so that a transition to the sensorless control can be performed in a relatively short period of time from the start of the motor M.

Further, in the control device 3 of the embodiment, the drive control of the motor M is ended when the γ-δ-axis current value Iγδ is smaller than the first threshold current I0 and the γ-δ-axis current value Iγδ is smaller than the second threshold current I1. This makes it possible to suppress the step-out state in the sensorless control.

Note that the present invention is not limited to the embodiment described above, and various modifications or alterations can be made without departing from the gist of the present invention.

For example, one of the first threshold current I0 and the second threshold current I1 may be used without providing the both. In this case, the current control may be omitted, and whether to perform the sensorless control or the drive control of the motor M may be selected.

Further, the determination unit 18 as the second determination unit determines whether or not the position estimation is possible based on the current flowing through the motor M by the three-phase short circuit control, but the position estimation in step S5 or S8 may be performed without the determination, that is, by omitting the second determination unit. In this case, the position estimation may fail, and control may be ended, for example, when the position estimation fails a predetermined number of times.

Further, the determination unit 18 has both the function as the first determination unit and the function as the second determination unit, but the both may be provided separately.

Further, it may be configured such that both the observer expressed by Formula 5 and an observer obtained by excluding the term including Vγ*′, Vδ*′, and ω\hat{ } from Formula 5.

Further, in steps S3 and S4, the determination may be performed based on the magnitude of the γ-axis current value Iγ or the δ-axis current value Iδ, instead of the magnitude of the γ-δ-axis current value Iγδ.

Further, examples of the method of calculating the estimated angular velocity ω\hat{ } and the estimated position θ\hat{ } include <Method Using Zero-Cross Timing of Induced Voltage>, <Method Using Speed Electromotive Force>, and <Method Using Magnetic Flux>, in addition to <Method Using Extended Electromotive Force> described above, and the method is not particularly limited.

### Example of <Method Using Zero-Cross Timing of Induced Voltage>

First, the estimation unit 8 obtains the estimated position θ\hat{ } based on a phase of an induced voltage generated in a phase in which no current flows among the U-phase, the V-phase, and the W-phase of the motor M at a zero-cross timing when the voltage of the phase in which no current flows becomes a midpoint potential (a voltage of ½ of a voltage of the power source P) of the voltage of the power source P. Note that a method of calculating the estimated angular velocity ω\hat{ } from the estimated position θ\hat{ } is similar to <Method Using Extended Electromotive Force> described above, and the description thereof will be omitted. Further, in a case where <Method Using Zero-Cross Timing of Induced Voltage> is adopted as the method of calculating the estimated angular velocity ω\hat{ } and the estimated position θ\hat{ }, the computation unit 6 obtains the induced voltage at the time of the zero-cross timing based on the input U-phase current value Iu, V-phase current value Iv, and W-phase current value Iw.

Further, in the case where <Method Using Zero-Cross Timing of Induced Voltage> is adopted as the method of calculating the estimated angular velocity ω\hat{ } and the estimated position θ\hat{ }, the computation unit 6 returns to step S1 and performs the three-phase short circuit control when the motor M is started or when the induced voltage of any phase is smaller than a threshold th′ in step S10 of FIG. 2 (step S10: Yes). Note that, when it is determined that the induced voltage of any phase is equal to or larger than the threshold th′ (step S10: No), the computation unit 6 continuously performs the sensorless control. For example, it is assumed that the threshold th′ is a minimum value of the induced voltage of any phase in a case where the sensorless control can be performed, and is obtained in advance by an experiment, a simulation, or the like. That is, the determination unit 18 as the first determination unit determines that the estimation unit 8 is in a state of being capable of the speed estimation and the position estimation and causes the sensorless control to continue when the induced voltage of any phase is equal to or larger than the threshold th′, and determines that the estimation unit 8 is in a state of being incapable of performing the speed estimation and the position estimation and causes the transition from the sensorless control to the three-phase short circuit control when the induced voltage of any phase is smaller than the threshold th′.

As described above, the three-phase short circuit control is performed when the motor M is started or when the induced voltage is relatively low and the determination unit 18 as the first determination unit determines that the position estimation is not possible also in the case where <Method Using Zero-Cross Timing of Induced Voltage> is adopted as the method of calculating the estimated angular velocity ω\hat{ } and the estimated position er, so that the estimation accuracy of the estimated position θ\hat{ } can be improved. In general, in the normal sensorless control (PWM control), when the motor M is started or when the induced voltage is relatively low (when the angular velocity of the rotor is relatively low), the current flowing through the motor M is relatively small, so that the zero-cross timing of the induced voltage is unclear, a signal-to-noise ratio of the induced voltage deteriorates, and the estimation accuracy of the position of the rotor deteriorates. Therefore, as compared with the normal sensorless control (PWM control), the current flowing through the motor M can be increased by performing the three-phase short circuit control when the motor M is started or when the inductive voltage is relatively low and the determination unit 18 determines that the position estimation is not possible as in the present embodiment, so that it is possible to clarify the zero-cross timing of the inductive voltage and to improve the estimation accuracy of the estimated position θ\hat{ }.

### Example of <Method Using Speed Electromotive Force>

First, the estimation unit 8 calculates a speed electromotive force eM generated in the motor M based on the γ-axis current value Iγ, the δ-axis current value Iδ, the γ-axis voltage command value Vγ*′, the δ-axis voltage command value Vδ*′, the estimated angular velocity ω\hat{ } stored in the storage unit 4, and the motor parameters that can be estimated in advance. Specifically, the estimation unit 8 calculates the speed electromotive force eM using the following Formula 9. Note that p denotes a time derivative operator d/dt. KE denotes an induced voltage constant. A winding resistance R\hat{ }, a δ-axis inductance Ld\hat{ }, and a q-axis inductance Lq\hat{ } are estimated values of motor parameters of the motor M to be controlled, and are estimated in advance by measurement or the like using the motor M. The reason why the estimated values are used instead of actual values of the motor parameters of the motor M is that the motor parameters vary depending on the temperature and the current flowing through the motor M.

$$\begin{matrix}[ Mathematical Expression 7 ] & \\ [ \begin{matrix}{V}_{γ} {*}^{′} \\ {V}_{δ} {*}^{′}\end{matrix} ] = [ \begin{matrix}R \hat{} + pLd \hat{} & - ω \hat{} Lq \hat{} \\ ω \hat{} Ld \hat{} & R \hat{} + pLq \hat{}\end{matrix} ] [ \begin{matrix}{i}_{γ} \\ {i}_{δ}\end{matrix} ] + [ \begin{matrix}0 \\ eM \times KE\end{matrix} ] & Formula 9\end{matrix}$$

Next, the estimation unit 8 obtains an estimated value of the current flowing through the motor M and an actual current based on the calculated speed electromotive force eM, and calculates the estimated angular velocity ω\hat{ } and the estimated position θ\hat{ } based on a current error between the estimated value and the actual current.

Further, in a case where <Method Using Speed Electromotive Force> is adopted as the method of calculating the estimated angular velocity ω\hat{ } and the estimated position θ\hat{ }, similarly to the case where <Method Using Zero-Cross Timing of Induced Voltage> is adopted as the method of calculating the estimated angular velocity ω\hat{ } and the estimated position θ\hat{ }, the computation unit 6 returns to step S1 and performs the three-phase short circuit control when the motor M is started or when the induced voltage of any phase is smaller than the threshold th′ in step S10 of FIG. 2 (step S10: Yes). Note that, when it is determined that the induced voltage of any phase is equal to or larger than the threshold th′ (step S10: No), the computation unit 6 continuously performs the sensorless control. That is, the determination unit 18 as the first determination unit determines that the estimation unit 8 is in a state of being capable of the speed estimation and the position estimation and causes the sensorless control to continue when the induced voltage of any phase is equal to or larger than the threshold th′, and determines that the estimation unit 8 is in a state of being incapable of performing the speed estimation and the position estimation and causes the transition from the sensorless control to the three-phase short circuit control when the induced voltage of any phase is smaller than the threshold th′.

As described above, the three-phase short circuit control is performed when the motor M is started or when the induced voltage is relatively low and the determination unit 18 as the first determination unit determines that the position estimation is not possible also in the case where <Method Using Estimated Speed Electromotive Force> is adopted as the method of calculating the estimated angular velocity ω\hat{ } and the estimated position θ\hat{ }, so that the estimation accuracy of the estimated position θ\hat{ } can be improved. In general, in the normal sensorless control (PWM control), when the motor M is started or when the induced voltage is relatively low (when the angular velocity of the rotor is relatively low), an error (dead time error) between a true value and each of the U-phase voltage command value Vu*, the V-phase voltage command value Vv*, and the W-phase voltage command value Vw* is relatively larger as the induced voltage is lower. Thus, a signal-to-noise ratio of the induced voltage deteriorates, and the estimation accuracy of the position of the rotor deteriorates. Therefore, as compared with the normal sensorless control (PWM control), the influence of the dead time error can be removed by performing the three-phase short circuit control when the motor M is started or when the induced voltage is relatively low and the determination unit 18 determines that the position estimation is not possible as in the present embodiment, so that it is possible to improve the signal-to-noise ratio of the induced voltage and to improve the estimation accuracy of the estimated position θ\hat{ } n.

### Example of <Method Using Magnetic Flux>

First, the estimation unit 8 calculates an α-axis magnetic flux λα and a β-axis magnetic flux λβ based on the γ-axis current value Iγ, the δ-axis current value Iδ the γ-axis voltage command value Vγ*′, the δ-axis voltage command value Vδ*′, and the motor parameters that can be estimated in advance. Specifically, the estimation unit 8 calculates the α-axis magnetic flux Δα and the β-axis magnetic flux λβ using the following Formula 10. Note that the following Formula 10 is obtained by the following Formulas 11 to 13. That is, when the definition as in the following Formula 12 is adopted in an observer (motor model) expressed by the following Formula 11, the following Formula 11 is expressed as the following Formula 13. Next, when the following Formula 13 is converted into an α-β axis system (fixed coordinate system), the following Formula 10 is obtained. Note that an x-axis voltage Vα in the fixed coordinate system corresponds to the γ-axis voltage command value Vγ*′, a β-axis voltage Vβ in the fixed coordinate system corresponds to the δ-axis voltage command value Vδ*′, an α-axis current ix in the fixed coordinate system corresponds to the γ-axis current value Iγ, and a β-axis current iβ in the fixed coordinate system corresponds to the δ-axis current value Iδ Further, λd denotes a d-axis magnetic flux, and λq denotes a q-axis magnetic flux.

$$\begin{matrix}[ Mathematical Expression 8 ] & \\ [ \begin{matrix}V α \\ V β\end{matrix} ] = [ \begin{matrix}R \hat{} + pLd \hat{} & 0 \\ 0 & R \hat{} + pLd \hat{}\end{matrix} ] [ \begin{matrix}i α \\ i β\end{matrix} ] + p [ \begin{matrix}λα \\ λβ\end{matrix} ] & Formula 10\end{matrix}$$

$$\begin{matrix}Mathematical Expression 9 ] & \\ [ \begin{matrix}V γ {*}^{′} \\ V δ {*}^{′}\end{matrix} ] = [ \begin{matrix}R \hat{} + pLd \hat{} & - ω \hat{} Lq \hat{} \\ ω \hat{} Ld \hat{} & R \hat{} + pLq \hat{}\end{matrix} ] [ \begin{matrix}i γ \\ i δ\end{matrix} ] + \\ [ \text{} \begin{matrix}0 \\ p ( Lg \hat{} - Ld \hat{} ) i δ\end{matrix} ] + {ω}^{\hat{}} [ \begin{matrix}- ( Lq \hat{} - Ld \hat{} ) i δ \\ KE\end{matrix} ] & Formula 11\end{matrix}$$

$$\begin{matrix}[ Mathematical Expression 10 ] & \\ λ = [ \begin{matrix}λ d \\ λ q\end{matrix} ] = [ \begin{matrix}KE \\ ( Lq \hat{} - Ld \hat{} ) i δ\end{matrix} ] & Formula 12\end{matrix}$$

$$\begin{matrix}[ Mathematical Expression 11 ] & \\ [ \begin{matrix}V γ {*}^{′} \\ V δ {*}^{′}\end{matrix} ] = [ \begin{matrix}R \hat{} + pLd \hat{} & - ω \hat{} Lq \hat{} \\ ω \hat{} Ld \hat{} & R \hat{} + pLq \hat{}\end{matrix} ] [ \begin{matrix}i γ \\ i δ\end{matrix} ] + p [ \begin{matrix}λ d \\ λ q\end{matrix} ] + {ω}^{\hat{}} [ \begin{matrix}- λ q \\ λ d\end{matrix} ] & Formula 13\end{matrix}$$

Next, the estimation unit 8 puts the calculated α-axis magnetic flux λα and β-axis magnetic flux λβ into the following Formula 14 to calculate the estimated position θ\hat{ }. Note that a method of calculating the estimated angular velocity ω\hat{ } from the estimated position θ\hat{ } is similar to <Method Using Extended Electromotive Force> described above, and the description thereof will be omitted.

$$\begin{matrix}[ Mathematical Expression 12 ] & \\ {θ}^{\hat{}} = {tan}^{\text{-1}} \frac{λβ}{λα} & Formula 14\end{matrix}$$

Further, in a case where <Method Using Magnetic Flux> is adopted as the method of calculating the estimated angular velocity ω\hat{ } and the estimated position θ\hat{ }, the computation unit 6 returns to step S1 and performs the three-phase short circuit control when the motor M is started or when the γ-δ-axis current value Iγδ or a γ-δ-axis voltage command value Vγδ*′ is smaller than a threshold th″ in step S10 of FIG. 2 (step S10: Yes). Note that, when it is determined that the γ-δ-axis current value Iγδ or the γ-δ-axis voltage command value Vγδ*′ is equal to or larger than the threshold th″ (step S10: No), the computation unit 6 continuously performs the sensorless control. For example, it is assumed that the threshold th″ is a minimum value of the γ-δ-axis current value Iγδ or the γ-δ-axis voltage command value Vγδ*′ in a case where the sensorless control can be performed, and is obtained in advance by an experiment, a simulation, or the like. That is, the determination unit 18 as the first determination unit determines that the estimation unit 8 is in the state of being capable of performing the speed estimation and the position estimation and causes the sensorless control to continue when the γ-δ-axis current value Iγδ or the γ-δ-axis voltage command value Vγδ*′ is equal to or larger than the threshold th″, and determines that the estimation unit 8 is in the state of being incapable of performing the speed estimation and the position estimation and causes the transition from the sensorless control to the three-phase short circuit control when the γ-δ-axis current value Iγδ or the γ-δ-axis voltage command value Vγδ*′ is smaller than the threshold th″.

As described above, the three-phase short circuit control is performed when the motor M is started or when the γ-δ-axis current value Iγδ or the γ-δ-axis voltage command value Vγδ*′ is relatively small and the determination unit 18 as the first determination unit determines that the position estimation is not possible also in the case where <Method Using Magnetic Flux> is adopted as the method of calculating the estimated angular velocity ω\hat{ } and the estimated position θ\hat{ }, so that the estimation accuracy of the estimated position θ\hat{ } can be improved. In general, in the normal sensorless control (PWM control), when the motor M is started or when the γ-δ-axis current value Iγδ or the γ-δ-axis voltage command value Vγδ*′ is relatively small (when the angular velocity of the rotor is relatively low), the error (dead time error) between the true value and each of the U-phase voltage command value Vu*, the V-phase voltage command value Vv*, and the W-phase voltage command value Vw* is relatively larger as the γ-δ-axis current value Iγδ or the γ-δ-axis voltage command value Vγδ*′ is smaller. Thus, a signal-to-noise ratio of the γ-δ-axis current value Iγδ or the γ-δ-axis voltage command value Vγδ*′ deteriorates, and the estimation accuracy of the position of the rotor deteriorates. Therefore, as compared with the normal sensorless control (PWM control), the influence of the dead time error can be removed by performing the three-phase short circuit control when the motor M is started or when the γ-δ-axis current value Iyo or the γ-δ-axis voltage command value Vγδ*′ is relatively small and the determination unit 18 determines that the position estimation is not possible as in the present embodiment, so that it is possible to improve a signal-to-noise ratio of a phase voltage of the motor M and to improve the estimation accuracy of the estimated position θ\hat{ }. Note that, instead of the γ-δ-axis current value Iγδ or the γ-δ-axis voltage command value Vγδ*′, the determination may be performed using the γ-axis current value Iγ, the γ-axis voltage command value Vγ*′, the δ-axis current value Iδ, and the δ-axis voltage command value Vδ*′.

### REFERENCE SIGNS LIST

1 Control system
2 Inverter
3 Control device
4 Storage unit
5 Drive circuit
6 Computation unit
7 Current value conversion unit
8 Estimation unit
9 Subtraction unit
10 Torque command value calculation unit
11 γ-δ current command value output unit
12 Subtraction unit
13 Subtraction unit
14 Voltage command value calculation unit
15, 16 Switch
17 Voltage command value conversion unit
18 Determination unit (first determination unit, second determination unit)
P Power source
C Capacitor
Se1 Current sensor
Se2 Current sensor
Se3 Current sensor

1. (canceled)

2. (canceled)

3. (canceled)

4. (canceled)

5. (canceled)

6. A control device that generates a drive signal for controlling an inverter driving a motor, the control device comprising:
a current value conversion unit that converts current flowing through the motor into a γ-axis current value and a δ-axis current value;
a γ-δ current command value output unit that outputs a γ-axis current command value and a δ-axis current command value;
a γ-δ voltage command value calculation unit that calculates a γ-axis voltage command value based on the γ-axis current value and the γ-axis current command value and calculates a δ-axis voltage command value based on the δ-axis current value and the δ-axis current command value;
a drive signal conversion unit that converts the γ-axis voltage command value and the δ-axis voltage command value into the drive signal;
an estimation unit that calculates an estimated position that is an estimated value of a position of the motor; and
a first determination unit that determines whether or not position estimation of the motor is possible by the estimation unit, wherein
an upper arm short circuit drive signal or a lower arm short circuit drive signal is generated when the motor is started or when the first determination unit determines that the position estimation of the motor is not possible, the upper arm short circuit drive signal being the drive signal for simultaneously turning on three-phase upper arm switching elements of the inverter and simultaneously turning off three-phase lower arm switching elements of the inverter, the lower arm short circuit drive signal being the drive signal for simultaneously turning off the three-phase upper arm switching elements of the inverter and simultaneously turning on the three-phase lower arm switching elements of the inverter, and
when the upper arm short circuit drive signal or the lower arm short circuit drive signal is generated, the estimation unit calculates an estimated extended electromotive force, which is an estimated value of an extended electromotive force generated in the motor, from the γ-axis current value and the δ-axis current value, and calculates the estimated position that is the estimated value of the position of the motor based on the estimated extended electromotive force.

7. The control device according to claim 6, comprising a second determination unit,
wherein the second determination unit determines whether or not the position estimation of the motor is possible based on the current flowing through the motor by the upper arm short circuit drive signal or the lower arm short circuit drive signal

8. The control device according to claim 7, wherein
the drive signal for supplying three-phase alternating current to the motor is generated when the second determination unit determines that the position estimation of the motor is possible.

9. The control device according to claim 8, wherein
when the second determination unit determines that a value of the current flowing through the motor is smaller than a threshold current and the position estimation of the motor is possible, a timer is started, the upper arm short circuit drive signal or the lower arm short circuit drive signal is generated, the estimated extended electromotive force, which is the estimated value of the extended electromotive force generated in the motor, is calculated from the γ-axis current value and the δ-axis current value, the estimated position that is the estimated value of the position of the motor is calculated based on the estimated extended electromotive force, and the drive signal for causing the current flowing through the motor to have a constant value is generated using the calculated estimated position, and
the upper arm short circuit drive signal or the lower arm short circuit drive signal is generated after a lapse of a first predetermined time.

10. The control device according to claim 8, wherein
the estimation unit calculates an estimated extended electromotive force, which is an estimated value of an extended electromotive force generated in the motor, based on the γ-axis current value, the δ-axis current value, the γ-axis voltage command value, and the δ-axis voltage command value, and calculates the estimated position that is the estimated value of the position of the motor based on the estimated extended electromotive force, and
the first determination unit determines that the position estimation is not possible when the estimated extended electromotive force is smaller than a threshold, and generates the upper arm short circuit drive signal or the lower arm short circuit drive signal.
